(19) United States
(12) Patent Application Publication
(10) Pub. No.: US 2026/0141497 A1
(43) Pub. Date: May 21, 2026

(54) RECONSTRUCTING OBSTRUCTED VISUAL INFORMATION IN AN OBSTRUCTED/OBSCURED IMAGE

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 18/952,705

(22) Filed: Nov. 19, 2024

(51) Int. Cl. G06T 5/77; G06T 7/11; G06T 11/60

(52) U.S. Cl. CPC G06T 5/77; G06T 7/11; G06T 11/60

(57) ABSTRACT

An electronic device, a method, and a computer program product reconstruct descriptive information that was not captured in an image due to an obstruction or obscuration. In response to a trigger to reconstruct an image that is partially obstructed, a processor configures the electronic device to identify an obstruction obfuscating a section of an image. The processor identifies first portion(s) of unobstructed descriptive information on another section. The processor associates the first portion(s) with contents of record(s) accessible in memory or communicated via the communications subsystem. The processor identifies second portion(s) of the descriptive information contained in the record(s) and obscured from the image. The processor delineates the image into multiple segments including first segment(s) encompassing the section with the obstruction separated from visible second segment(s). The processor reconstructs an unobstructed image by inpainting, into the first segment(s) of the image, the second portion(s) of descriptive information from the record(s).

### CROSS REFERENCE TO RELATED APPLICATIONS

The present application is related to commonly owned U.S. patent application filed on even date herewith and entitled “Reconstructing Descriptive Visual Information in an Obstructed Image via Accessing Second Party Data”, having the same named inventors, the disclosure of which is hereby incorporated by reference in its entirety.

### BACKGROUND

### 1. Technical Field

The present disclosure relates generally to electronic devices that present images, and more particularly to electronic devices with tools for digitally editing images.

### 2. Description of the Related Art

Photo editing has significantly evolved from manual darkroom techniques to advanced digital processes. Manual darkroom techniques involve physical manipulation of film and prints, a labor-intensive and time-consuming task. The introduction of software digital photo editing transformed photo editing, making photo editing more accessible and versatile. Electronic devices such as smartphones, laptops, and tablets may include photo editing software.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device in which the features of the present disclosure are advantageously implemented for reconstructing descriptive information that is at least partially obscured or was not captured in an image due to an obstruction, according to one or more embodiments;

FIG. 2 is a simplified block diagram of the communication device having additional communication interfaces for wireless communications, according to one or more embodiments;

FIG. 3 is processing flow diagram for obstructed image reconstruction of an input image to an output image, according to one or more embodiments;

FIG. 4 is another obstructed image from a first vantage point of a statue and inscription in a background with a user and an obstruction in a foreground, according to one or more embodiments;

FIG. 5 is a second image of the statue and inscription that are unobstructed and from a second vantage point, according to one or more embodiments;

FIG. 6 is a reconstructed image from the first vantage point of the statue and the inscription in the background with the user after replacing the obstruction with descriptive information retrieved from a network source and that was previously obscured/hidden by the obstruction in the obstructed/obscured image of FIG. 4, according to one or more embodiments;

FIG. 7 is an obstructed/obscured image of a user posed with an object depicted as a roadway marker having obscured text, according to one or more embodiments;

FIG. 8 is a communication record depicted as a texting interface that contains descriptive information about the obstructed/obscured image of FIG. 7, according to one or more embodiments;

FIG. 9 is a reconstructed image of the user posed with the roadway marker with reconstructed text based on the communication record, according to one or more embodiments; and

FIGS. 10A-10B (collectively “FIG. 10”) are a flow diagram presenting a method for performing more realistic and accurate image editing by reconstructing descriptive information that was not captured in the image due to an obstruction or obscuration, according to one or more embodiments.

### DETAILED DESCRIPTION

According to aspects of the present disclosure, an electronic device, a method and a computer program product provide techniques for performing more realistic and accurate image editing by reconstructing descriptive information that was not captured in the image due to an obstruction or obscuration. Conventional photo editing software relies upon information from only within the image for reconstructing a realistic background/foreground within an erased portion of the image. Some photo editing software has incorporated artificial intelligence (AI) technology capable of erasing items in a photographic image and automatically adding new elements to fill the erasure, creating a natural looking image without the erased items. This process does not provide a good result, particularly when the object being removed and replaced with a copy of another part of the image is descriptive information within the in-focus foreground/background image. For example, replacing text that is partially erased or obscured with a plain background or foreground patch matching the remainder of the image creates a glaring inaccuracy in the edited image. According to one or more aspects of the present disclosure, the descriptive information that is obscured in the image is retrieved from another source having the original details and incorporated into the image to achieve a more realistic and accurate reconstruction.

In one or more embodiments, the electronic device includes a memory that stores an image obstruction mitigation module. The electronic device includes a communications subsystem connectable to a communication network. A processor of the electronic device is communicatively coupled to the memory and the communications subsystem. In response to a trigger to reconstruct a first image that is partially obstructed, the processor is configured to cause the electronic device to identify in the first image an obstruction obfuscating a section of the first image containing obstructed content. The processor is configured to cause the electronic device to identify at least one first portion of descriptive information on another section of the first image that is unobstructed. The processor is configured to cause the electronic device to associate the at least one first portion of the descriptive information with contents of one or more record accessible in the memory or communicated via the communications subsystem. The processor is configured to cause the electronic device to identify at least one second portion of the descriptive information contained in the one or more record and that is obscured from the first image. The processor is configured to cause the electronic device to delineate the first image into multiple segments including at least one first segment encompassing the section with the obstruction and which separates the obstruction from at least one second segment encompassing a visible portion of the other section of the first image that is unobstructed. The processor is configured to cause the electronic device to reconstruct an unobstructed first image by inpainting, into the at least one first segment of the first image, the at least one second portion of descriptive information from the one or more record.

The present disclosure locates or determines original information that is obstructed in an image and replaces the obstruction with the correct original information, enhancing visual appeal and completeness of images when undesired obstructions are removed and replaced in the images with digital editing. Unlike simple visual extrapolation types of photographic editing, the present disclosure provides techniques for identifying descriptive information that is unobstructed in the image and uses that information to locate and retrieve missing descriptive information from network sources. Reconstructing an image having missing text, for example, requires more than just visual cues. Contextual understanding of what is missing and identifying other sources for the missing descriptive information is required.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined primarily by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural, functional, or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

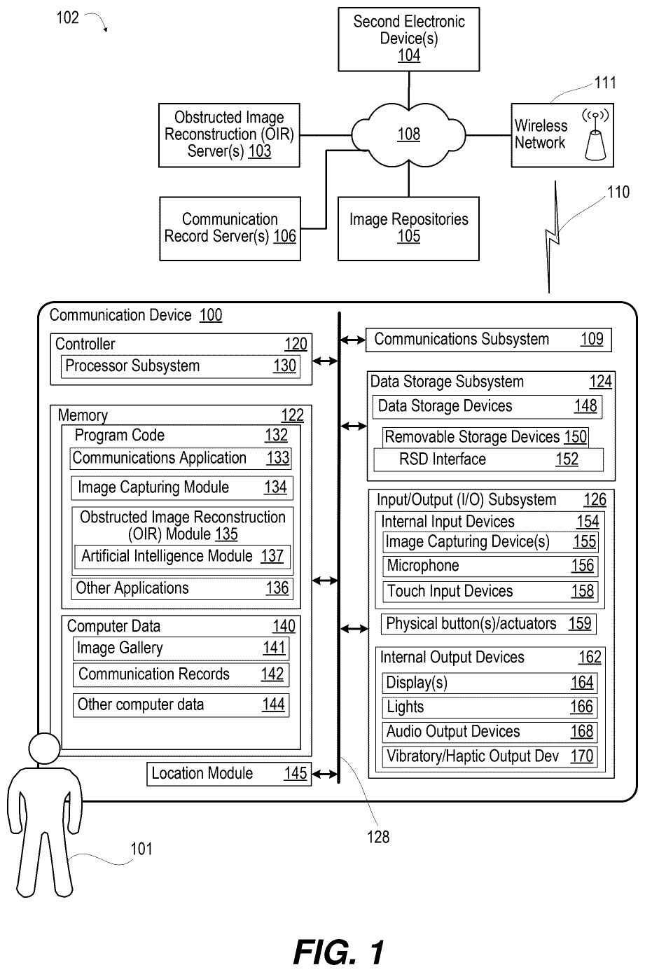

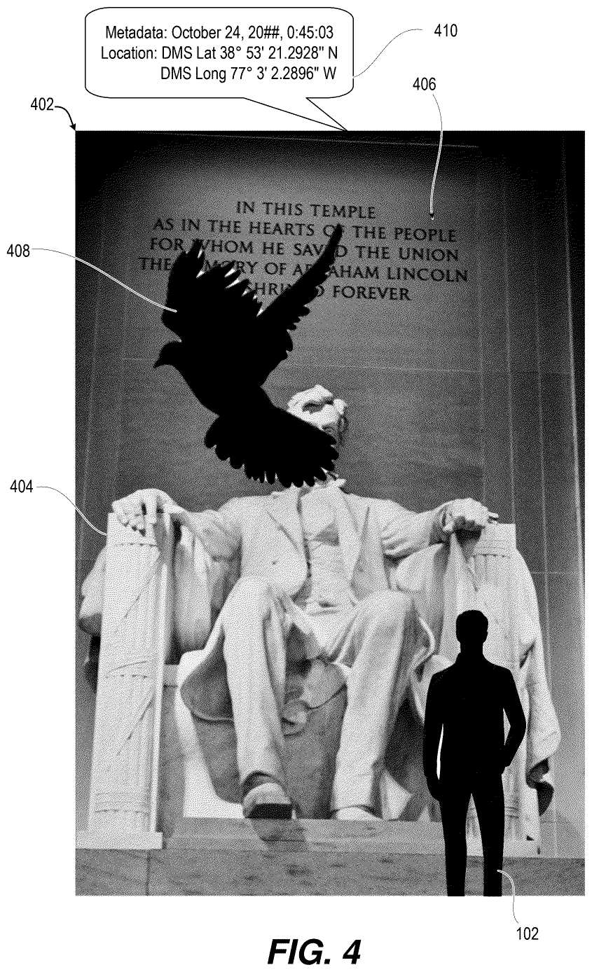

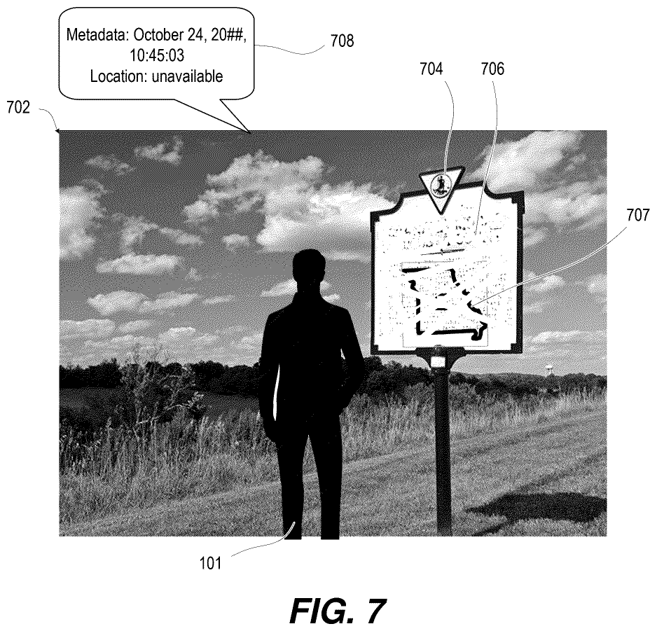

FIG. 1 presents a simplified functional block diagram of an electronic device in which the features of the present disclosure are advantageously implemented for accurately reconstructing descriptive information that was not captured in the image due to an obstruction or which is unreadable due to being skewed, marked over, or erased from the captured version of the image. The obstruction wholly or partially obscures descriptive information. In an example, the obstruction is an object, described below with regard to FIG. 4. In another example, the obstruction is due to surface marring (e.g., erasure, staining, and marking) of a planar or nonplanar object captured in an image and that presents descriptive information, described below with regard to FIG. 7. In one or more embodiments, the electronic device includes additional communications functionality that enables electronic device to be referred to as communication device 100, which operates as a mobile user device for user 101 in communication environment 102.

Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices. User 101 may use one or more second electronic devices similar or identical to communication device 100 with preferences shared across devices.

Aspects of the present disclosure may be implemented at least in part in obstructed image reconstruction (OIR) server(s) 103 that includes some or all of the components and functionality described herein. In an example, to reduce power consumption and processing capacity requirements, communication device 100 may distribute processing tasks for obstructed image reconstruction to OIR server(s) 103. In the specific example of FIG. 1, communication environment 102 may further include second electronic device(s) 104, image repositories 105, and communication record server(s) 106, which are accessible to communication device 100 through communication network 108. Communication device 100 includes communications subsystem 109 that connects via wired or wireless channel 110 to node 111 (e.g., wireless access point, cellular tower) to communicatively connect to OIR server(s) 103, second electronic device(s) 104, image repositories 105, and communication record server(s) 106 via one or more communication network 108.

In addition to communications subsystem 109, communication device 100 may include controller 120, memory 122, data storage subsystem 124 and input/output (I/O) subsystem 126. To enable management by controller 120, system interlink 128 communicatively connects controller 120 with communications subsystem 109, memory 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor 130, which includes one or more central processing units (CPUs) or data processors. Processor 130 can include one or more digital signal processors and graphics processing units (GPUs), etc. that can be integrated with data processor(s). Processor 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

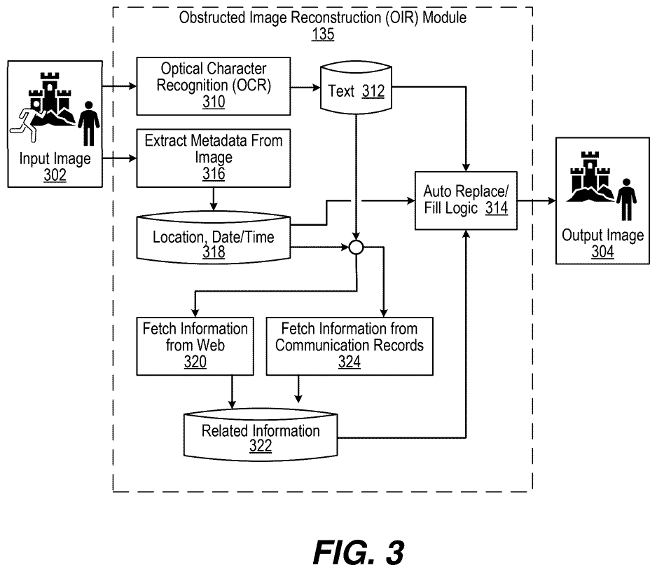

Memory 122 stores program code 132 for execution by processor 130 to provide the functionality described herein. Program code 132 includes applications such as communication application 133 for communicating with second electronic device(s) 104, image capturing module 134 for capturing images that may be obscured, and OIR module 135, and other applications 136. OIR module 135 may include artificial intelligence (AI) model 137. Additional functionality and features of OIR module 135 are described below with regard to FIG. 3.

In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner. Memory 122 further includes operating system (OS), firmware interface, such as basic input/output system (BIOS) or Uniform Extensible Firmware Interface (UEFI), and firmware, which also includes and may thus be considered as program code 132.

Program code 132 may access, use, generate, modify, store, or communicate computer data 140, such as image gallery 141, communication records 142, and other computer data 144 for OIR module 135 to use in reconstructed obstructed images. Location module 145 may provide a location of communication device 100 for adding to metadata of images captured by communication device 100. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 109. Communication device 100 may store, modify, present, or transmit computer data 140. Computer data 140 may be organized in one of a number of different data structures. Common examples of computer data 140 include video, graphics, text, and images. Computer data 140 can also be in other forms of flat files, databases, and other data structures.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing. I/O subsystem 126 may include internal output devices 162 such as display(s) 164, lights 166, audio output devices 168, and vibratory or haptic output devices 170.

In one or more embodiments, OIR module 135 includes AI model 137 that is trained to recognize objects such as obstruction and to recognize descriptive information such as text and symbols. OIR module 135 and AI model 137 may be stored in memory 122 of communication device 100 and be executed by controller 120 to perform various aspects of the functionality of the present disclosure. Training of AI model 137 is the process by which AI models are trained to perform specific tasks or achieve certain objectives. The training involves providing the model with a large amount of data and allowing the model to learn from patterns and relationships within that data. Controller 120 may include various functionalities that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

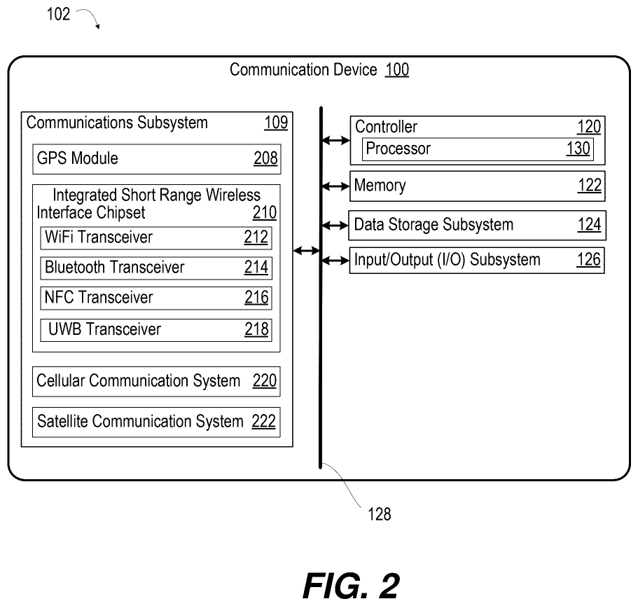

FIG. 2 is a simplified block diagram of communication device 100 having additional communication interfaces for wireless communications. In one or more embodiments, controller 120, via communications subsystem 109, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 109 includes a global positioning system (GPS) module 208 that receives GPS broadcasts from GPS satellites to obtain geospatial location information. In one or more embodiments, controller 120, via communications subsystem 109, communicates via a wireless local area network (WLAN) link using one or more IEEE 802.11 WLAN protocols with an access point. In one or more embodiments, controller 120, via communications subsystem 109, may communicate via an OTA cellular connection with radio access networks (RANs). In an example, communication device 100, via communications subsystem 109, connects via RANs of a terrestrial network that is communicatively connected to a network server. In one or more embodiments, communications subsystem 109 includes integrated short range wireless interface chipset 210 having one or more of Wi-Fi component 212, Bluetooth (BT) transceiver (TxRx) 214, near field communication (NFC) transceiver 216, and ultra-wideband transceiver 218. In one or more embodiments, communications subsystem 109 further includes long distance communication capabilities including cellular communication system 220 and satellite communication system 222.

With particular reference to FIG. 1, according to aspects of the present disclosure, an electronic device such as communication device 100 includes memory 122 that stores image obstruction mitigation (OIR) module 135. Communication device 100 includes communications subsystem 109 connectable to a communication network. Processor 130 of communication device 100 is communicatively coupled to communications subsystem 109 and memory 122. In response to a trigger to reconstruct a first image that is partially obstructed, processor 130 is configured to cause communication device 100 to identify in the first image an obstruction obfuscating a section of the first image containing obstructed content. Processor 130 is configured to cause communication device 100 to identify at least one first portion of descriptive information on another section of the first image that is unobstructed. Processor 130 is configured to cause communication device 100 to associate the at least one first portion of the descriptive information with contents of one or more record accessible in memory 122 or communicated via communications subsystem 109, such as from image repositories 105 and communication record server(s) 106. Processor 130 is configured to cause communication device 100 to identify, from the one or more records, at least one second portion of the descriptive information contained in the one or more record and that is obscured from the first image. Processor 130 is configured to cause communication device 100 to delineate the first image into multiple segments including at least one first segment encompassing the section with the obstruction and which separates the obstruction from at least one second segment encompassing a visible portion of the other section of the first image that is unobstructed. Processor 130 is configured to cause communication device 100 to reconstruct an unobstructed first image by inpainting, into the at least one first segment of the first image, the at least one second portion of descriptive information from the one or more record.

In one or more embodiment, the one or more record is or includes a second image. The processor is configured to cause communication device 100 to associate the at least one first portion of the descriptive information with contents of the second image. In one or more particular embodiments, processor 130 is configured to cause communication device 100 to delineate the second image into multiple segments including at least one primary segment corresponding to the section with the obstruction in the first image and at least one secondary segment corresponding to the visible portion of the other section of the first image that is unobstructed. Processor 130 is configured to cause communication device 100 to reconstruct an unobstructed first image by inpainting, into the at least one first segment of the first image, the at least one second portion of descriptive information from the at least one primary segment from the second image. In one or more specific embodiments, processor 130 is configured to cause communication device 100 to determine, from the first image, one or more image characteristics from a group comprising: (i) coloration; (ii) orientation; (iii) size; (iv) skew; and (v) font of the section of the descriptive information. Processor 130 is configured to cause communication device 100 to alter one or more corresponding image characteristics of the section of the unobstructed descriptive information received from the primary segment of the second image to match the one or more image characteristics of the first image.

In one or more embodiments, memory 122 includes at least one communication application 133. The one or more record is, or includes, one or more communication record 142 (e.g., SMS text, application direct messaging, email, electronic facsimile) received by or transmitted by communication device 100 via at least one communication application 133. Processor 130 is configured to cause communication device 100 to associate the at least one first portion of the descriptive information with textual contents from one or more communication record 142. Processor 130 is configured to cause communication device 100 to reconstruct the unobstructed first image by inpainting, into the at least one first segment of the first image, descriptive information obtained from one or more communication record 142. In particular, the at least one second portion of descriptive information is, or includes, textual content from one or more communication record 142 combined with nontextual visual content that corresponds to portions of the first image adjacent to the at least one first portion that is obstructed. In one or more specific embodiments, one or more communication record 142 is, or includes, at least one of a short message service (SMS) record and an email.

In one or more particular embodiments, in identifying the at least one second portion of the descriptive information contained in the one or more record and that is obscured from the first image, processor 130 is configured to cause communication device 100 to locate one or more of the descriptive information obfuscated in the first image by matching and extrapolating a location of the descriptive information in the other section of the first image.

In one or more embodiments, communication device 100 includes image capturing device 155 communicatively coupled to processor 130. Processor 130 is configured to cause communication device 100 to photographically capture the first image using the image capturing device. In an example, processor 130 is configured to cause communication device 100 to detect the activation trigger to reconstruct the first image based on capturing the first image. In another example, processor 130 is configured to cause communication device 100 to present a preview of the first image with at least one control whose activation is the activation trigger to reconstruct the first image.

FIG. 3 is processing flow diagram for obstructed or obscured image reconstruction by processor execution of OIR module 135 to generate, from input image 302 having obstructed/obscured sections, output image 304 that is a reconstructed, unobstructed and/or unobscured image. In block 310, optical character recognition (OCR) is performed on input image 302, resulting in text data 312 that is provided to block 314 for auto replace/fill logic. In one or more embodiment, replace and fill processing may be performed by delineation and inpainting. In block 316, extraction of metadata from input image 302 is performed to obtain metadata such as location, date/time data 318 that is provided to block 314. In one or more embodiments, text data 312 and location, date/time data 318 are provided to block 320 to provide or enable determination of source location information that can be used for fetching image filling information from the web, resulting in capturing related information 322 that can be used to replace and fill descriptive information that had been previously obstructed or obscured. In one or more embodiments, text data 312 and location, date/time data 318 are provided to block 324 for fetching additional related information 322 from one or more communication record (e.g., short message service (SMS) text, emails, electronic file transfer (EFT) documents).

FIG. 4 is first image 402 from a first vantage point of statue 404 and inscription 406 in a background with user 61 and obstruction 408 (i.e., a bird) in a foreground that partially obfuscates statue 404 and inscription 406. One or both of statue 404 and inscription 406 provide descriptive information that enables searching for a source from which the obfuscated descriptive information can be determined/retrieved. In an example, the remaining visual or graphical descriptive information of statue 404 is sufficient to enable image matching with an unobscured version of the captured image. In another example, textual descriptive information of inscription 406 provides enough words for word matching to a full version. The matching involves retrieving identifying details from the unobscured sections of the image and searching for and locating another copy of the image that is an unobscured version of the image.

In one or more embodiments, first image 402 includes metadata 410 that captures device and contextual information associated with image capture and post-capture processing. In an example, metadata 410 includes time/date and location information: “Metadata: Oct. 24, 20##, 0:45:03, Location: Degree-Minute-Seconds (DMS) Latitude 38° 53′ 21.2928″ N, DMS Longitude 77° 3′ 2.2896″ W”. Communication device 100 (FIG. 1) may use metadata such time/date and location to search for and retrieve descriptive information.

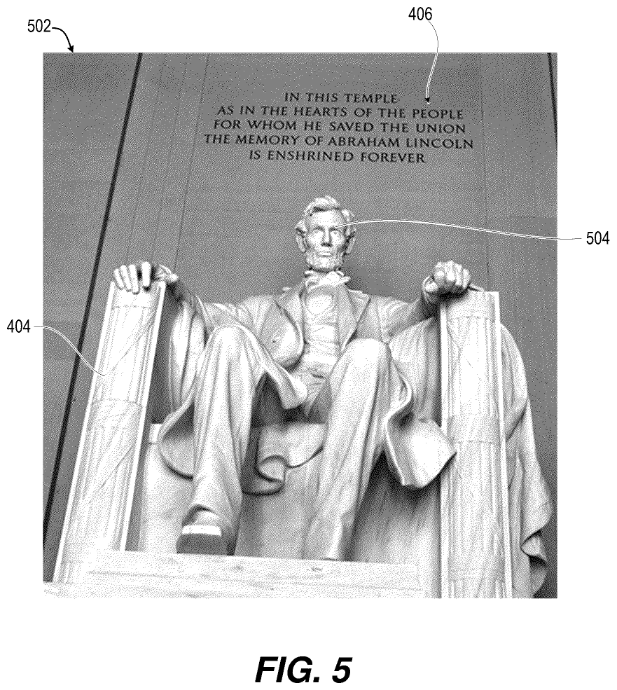

FIG. 5 presents second image 502 from a second vantage point of statue 404 with visual or graphical descriptive information of face 504 of statue 404 that is unobstructed. In addition, the following textual descriptive information of inscription 406 is also unobstructed. Second image 502 is also of a different size, color characteristics, cropping, and resolution as compared to first image 402 (FIG. 4). Although the second vantage point alters the orientation, size, skewing, and position of face 504 and inscription 406 in second image 502 as compared to first image 402 (FIG. 4) from the first vantage point, second image 502 provides descriptive information that is obfuscated in first image 402 (FIG. 4).

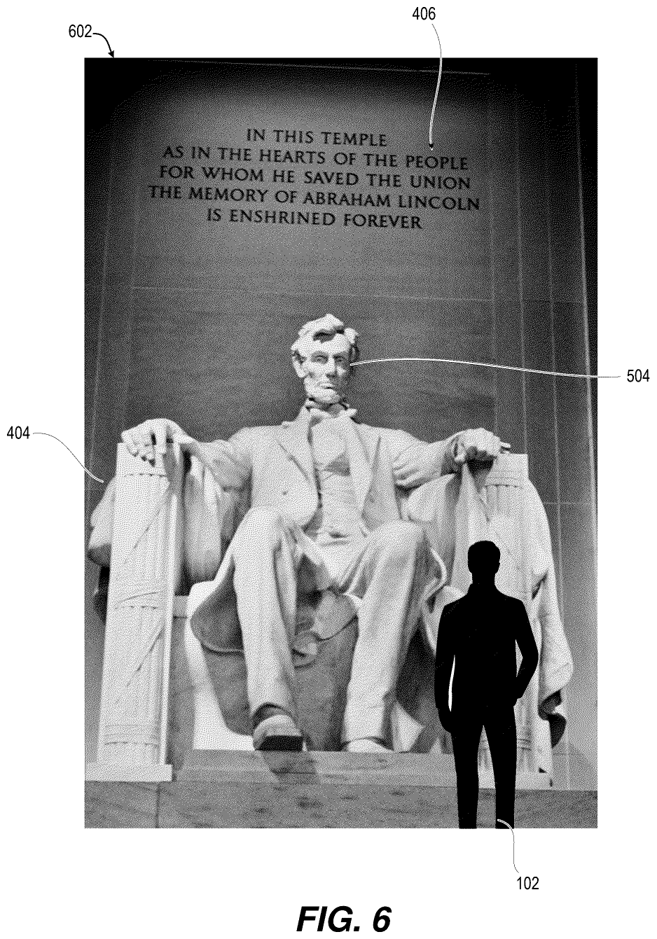

FIG. 6 provides reconstructed image 602 from the first vantage point of statue 404 and inscription 406 in the background that are both fully visible and not obfuscated, with user 61 in the foreground. Portions of inscription 406 and face 504 are retrieved from the second image 502 (FIG. 5) and inpainted in segments previously obfuscated by obstruction 408 (FIG. 4) after altering the presentation (e.g., color characteristics, size, skew, orientation, and position) to match other portions of descriptive information that is not obstructed or obscured in first image 402 (FIG. 4).

FIG. 7 is obstructed/obscured image 702 of user 101 posed with an object depicted as roadway marker 704 having obscured text 706. In an example, glare from the sun, damage/weathering of obscured text 706, or accumulated ice/snow have rendered text 706 illegible. The obscured portions may include portions that image enhancement techniques may restore descriptive information and be considered an unobstructed area. The obscured portions may be sufficiently obscured that the descriptive information is not retrievable from the original image data. Those sufficiently obscured portions made be one or more segments of an obstruction. Similarly, an actual object that forms a physical obstruction in an image may be opaque or semi-transparent at least in portions, such as looking through a glass component. The obstruction may partially obstruct and partially obscure descriptive information. Physical damage to descriptive portions may be confined to an area with some portions obstructed or obscured to be a virtual obstruction that may reconstructed using the delineating segments and inpainting as described herein. With continued reference to FIG. 7, obscured text 706 is missing a heading “Jackson County, Missouri” in large font above graphical map image 707 of the State of Missouri and Jackson County. Graphical map image 707 is also partially obstructed or obscured. Image 702 may include invisible descriptive information such as metadata 708: “Oct. 24, 20##, Location: unavailable”. In an example, the communication device 100 (FIG. 1) may be in an out of service area for receiving cellular or GPS location information due terrain. In another example, image capture settings may have location services omitted from images for personal privacy preferences. In an additional example, the image may be a copied image (e.g., screen shot) that removes some or all metadata. User 101 may not notice that text 706 is not legible in image 702 or may later prefer that previously legible text was still visible.

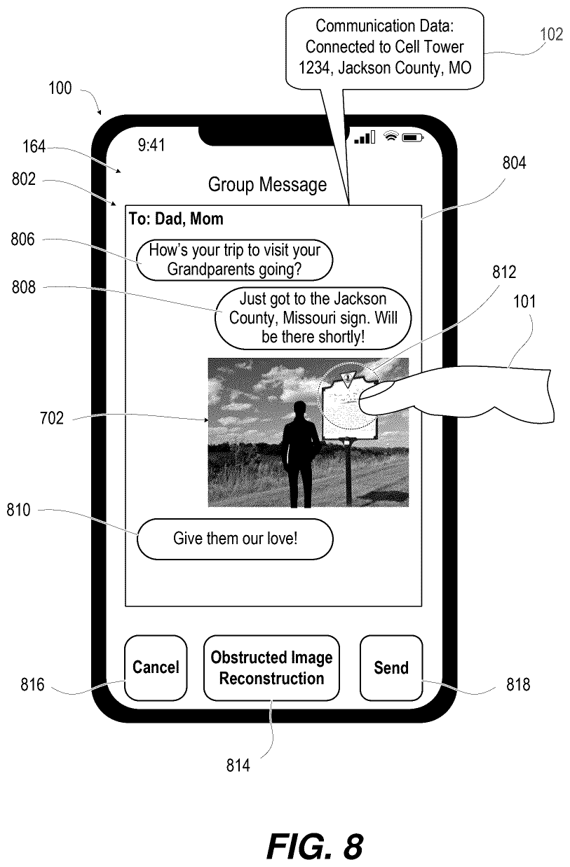

FIG. 8 is a communication record depicted as texting interface window 802 presented on display 164 of communication device 100. The communication record contains descriptive information about obstructed/obscured image 702. In an example, group message 804 between Dad, Mom, and user 101 includes received text 806 that provides: “How's your trip to visit your Grandparents going?” Then sent text 808 provides “Just got to the Jackson Count, Missouri sign. Will be there shortly!”. Then obstructed/obscured image 702 is sent. In response, received text 810 provides: “Give them our love!” According to aspects of the present disclosure, user 101 may trigger a process for finding and inpainting the missing descriptive information such as by touching area 812. In response, communication device 100 may enable and present obstructed image reconstruction control 814 in addition to cancel control 816 and send control 818. Upon user selection of obstructed image reconstruction control 814, communication device 100 performs obstructed image reconstruction on obstructed/obscured image 702.

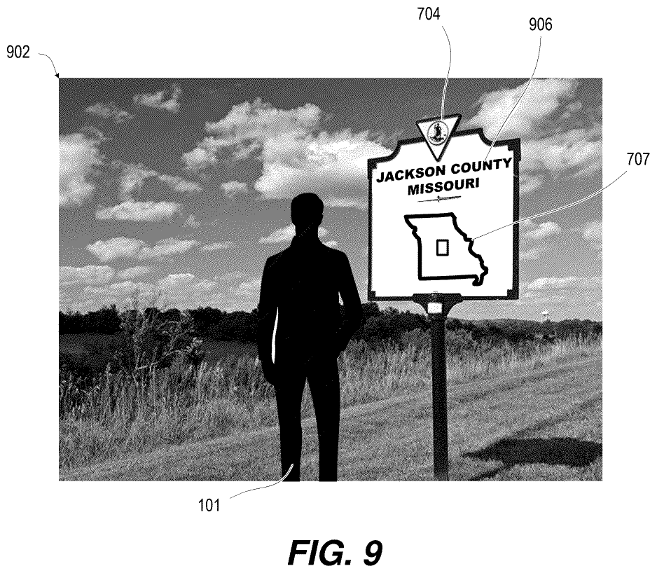

FIG. 9 illustrates reconstructed image 902 of user 101 posed with roadway marker 704 as originally depicted in obstructed/obscured image 702 (FIG. 7) but with reconstructed text 906 of “Jackson County, Missouri” replacing obscured text 706 (FIG. 7). Identification of the missing text may be based at least in part on metadata 708 of obstructed/obscured image 702 (FIG. 7), enabling a search of similarly shaped roadway markers in that location. Identification of the missing text may be based at least in part on based on the communication record, in particular text messaging provided by group message 804 (FIG. 8) either directly providing the missing text or providing clues for further searching. In one or more embodiments, obstructed or obscured portions such as graphical map image 707 may be restored by recognizing the shapes of the State of Missouri and a box for Jackson County and completing the tracing of these graphical elements. In one or more embodiments, an attempt to locate an image or description of roadway marker 704 may be attempted to validate reconstruction; however, in certain circumstances a particular subject of the image may not be accessible from network sources. Aspects of the present disclosure may pursue reconstruction based solely on contents of obstructed/obscured image 702 and communication records.

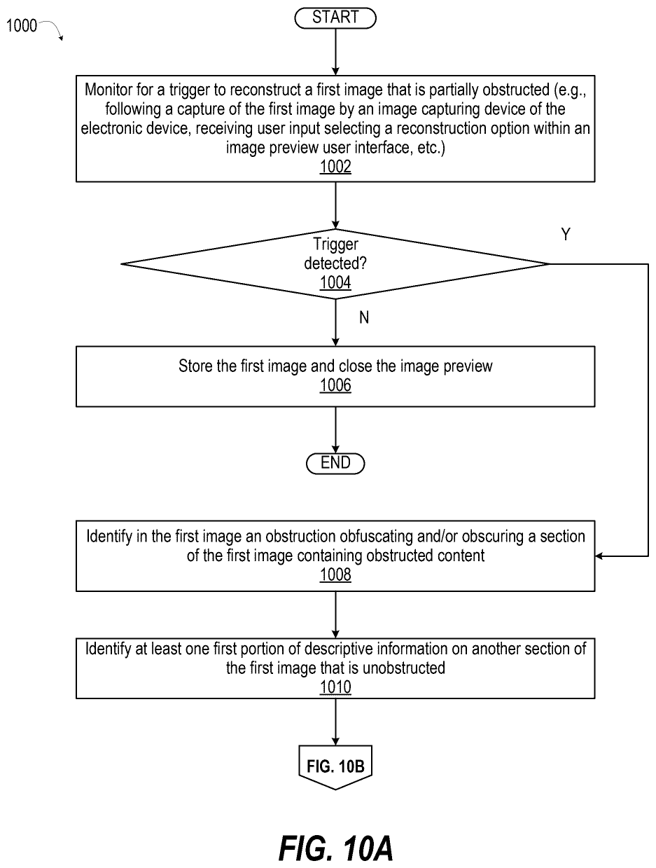

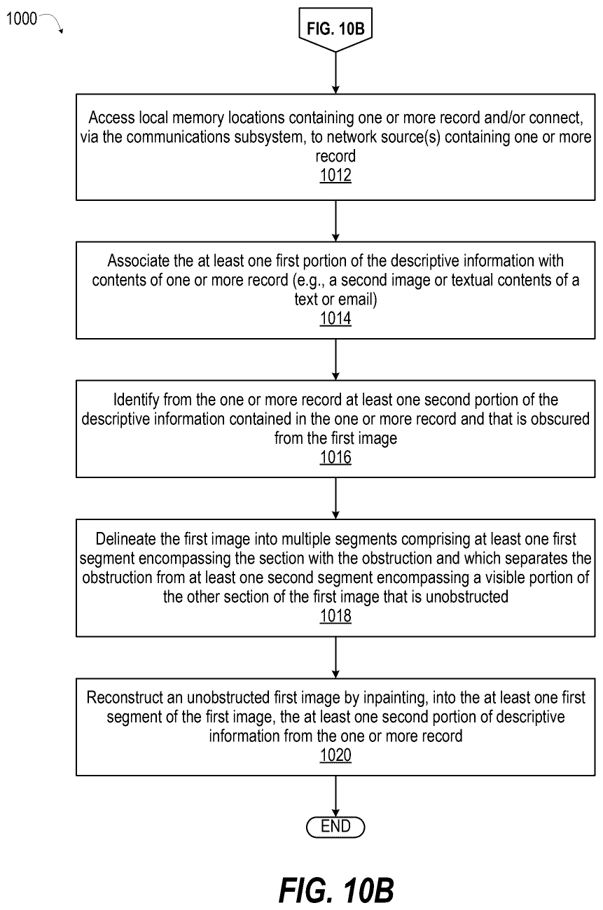

FIGS. 10A-10B (collectively “FIG. 10”) are a flow diagram presenting method 1000 for image editing by reconstructing descriptive information that is obscured or was not captured in the image due to an obstruction. In particular method 1000 uses visible unobstructed descriptive information and invisible information (e.g., metadata) from the image to locate missing information in another image or communication record. The description of method 1000 (FIG. 10) is provided with general reference to the specific components illustrated within the preceding FIGS. 1-9 . Specific components referenced in method 1000 (FIG. 10) may be identical or similar to components of the same name used in describing preceding FIGS. 1-9 . In one or more embodiments, controller 120 (FIG. 1) configures communication device 100 (FIG. 1) or a similar computing device to provide the described functionality of method 1000 (FIG. 10).

With reference to FIG. 10A, method 1000 includes monitoring for a trigger to reconstruct a first image that is partially obstructed (e.g., following a capture of the first image by an image capturing device of the electronic device, receiving user input selecting a reconstruction option within an image preview user interface, etc.) (block 1002). Method 1000 includes determining whether a trigger is detected (decision block 1004). In response to determining that a trigger is not detected, method 1000 includes storing the first image and closing the image preview (block 1006). Then method 1000 ends. In response to determining that a trigger is detected, method 1000 includes identifying in the first image an obstruction obfuscating and/or obscuring a section of the first image containing obstructed content (block 1008). Method 1000 includes identifying at least one first portion of descriptive information on another section of the first image that is unobstructed (block 1010). Then method 1000 proceeds to locally or remotely access records in block 1012 of FIG. 10B.

With reference to FIG. 10B, method 1000 includes accessing local memory locations containing one or more record and/or connecting, via the communications subsystem, to network source(s) containing one or more record (block 1012). Method 1000 includes associating the at least one first portion of the descriptive information with contents of one or more record (e.g., a second image or textual contents of a text or email) (block 1014). In an example, the communication record is a text or email that arose contemporaneously with capture of the first image and discusses circumstances associated with the first image. The circumstances may directly provide missing descriptive information or provide clues that enable searching for the missing descriptive information. Method 1000 includes identifying from the one or more record at least one second portion of the descriptive information contained in the one or more record and that is obscured from the first image (block 1016). Method 1000 includes delineating the first image into multiple segments comprising at least one first segment encompassing the section with the obstruction and which separates the obstruction from at least one second segment encompassing a visible portion of the other section of the first image that is unobstructed (block 1018). Method 1000 includes reconstructing an unobstructed first image by inpainting, into the at least one first segment of the first image, the at least one second portion of descriptive information from the one or more record (block 1020). Then method 1000 ends.

In one or more embodiments, the one or more record is, or includes, a second image that is unobstructed. In one or more particular embodiments, method 1000 may further include delineating the second image into multiple segments comprising at least one primary segment corresponding to the section with the obstruction in the first image and at least one secondary segment corresponding to the visible portion of the other section of the first image that is unobstructed. Method 1000 may further include reconstructing an unobstructed first image by inpainting, into the at least one first segment of the first image, the at least one second portion of descriptive information from the at least one primary segment from the second image. In one or more specific embodiments, method 1000 may further include determining, from the first image, one or more image characteristics from a group comprising: (i) coloration; (ii) orientation; (iii) size; (iv) skew; and (v) font of the section of the descriptive information. Method 1000 may further include altering one or more corresponding image characteristics of the section of the unobstructed descriptive information received from the primary segment of the second image to match the one or more image characteristics of the first image.

In one or more embodiments, method 1000 may further include associating the at least one first portion of the descriptive information with textual contents from the one or more record comprising one or more communication record communicated via at least one communication application executed by a processor of the electronic device. Method 1000 may further include reconstructing the unobstructed first image by inpainting, into the at least one first segment of the first image, the at least one second portion of descriptive information comprising textual content retrieved from the one or more communication record combined with nontextual visual content that corresponds to adjacent portions of the first image. In one or more embodiments, the one or more communication record is, or includes, at least one of a short message service (SMS) record and an email.

In one or more embodiments, in identifying the at least one second portion of the descriptive information contained in the one or more record and that is obscured from the first image, method 1000 further includes locating one or more of the descriptive information obfuscated in the first image by matching and extrapolating a location of the descriptive information in the other section of the first image.

In one or more embodiments, method 1000 may further include photographically capturing the first image using an image capturing device of the electronic device. In an example, method 1000 further includes detecting the activation trigger to reconstruct the first image based on detecting capture of the first image. In another example, method 1000 further includes in presenting, on a display of the electronic device, a preview of the first image and at least one control whose user selection is the activation trigger to reconstruct the first image.

According to aspects of the present disclosure, the communication device 100 (FIG. 1), method 1000 (FIG. 10), and computer program product, such as RSD 150 (FIG. 1), provides techniques for enabling reconstructing descriptive information that was not captured in a photographic image due to an obstruction or obscuration. In particular, method 1000 uses visible unobstructed descriptive information and invisible information (e.g., metadata) from the image to locate missing information in another image or communication record. Aspects of the present disclosure further enable more complete and natural looking image editing by modifying formatting of inpainted descriptive content to align with the remaining information within the image. Conventional photo editing software relies upon information only within the image for reconstructing a realistic background within the erased portion. In particular, text that is partially erased/unclear creates a glaring inaccuracy. In the present disclosure, the descriptive information is retrieved from another source (e.g., second image or communication record) and incorporated into the image to achieve the realistic and accurate reconstruction.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a memory that stores an image obstruction mitigation module;
a communications subsystem connectable to a communication network; and
a processor communicatively coupled to the memory and the communications subsystem, and which is configured to cause the electronic device to:
in response to a trigger to reconstruct a first image that is partially obstructed:
identify in the first image an obstruction obfuscating a section of the first image containing obstructed content;
identify at least one first portion of descriptive information on another section of the first image that is unobstructed;
associate the at least one first portion of the descriptive information with contents of one or more record accessible in the memory or communicated via the communications subsystem;
identify at least one second portion of the descriptive information contained in the one or more record and that is obscured from the first image;
delineate the first image into multiple segments comprising at least one first segment encompassing the section with the obstruction and which separates the obstruction from at least one second segment encompassing a visible portion of the other section of the first image that is unobstructed; and
reconstruct an unobstructed first image by inpainting, into the at least one first segment of the first image, the at least one second portion of descriptive information from the one or more record.

2. The electronic device of claim 1, wherein the one or more record comprises a second image and the processor is configured to cause the electronic device to associate the at least one first portion of the descriptive information with contents of the second image.

3. The electronic device of claim 2, wherein the processor is configured to cause the electronic device to:
delineate the second image into multiple segments comprising at least one primary segment corresponding to the section with the obstruction in the first image and at least one secondary segment corresponding to the visible portion of the other section of the first image that is unobstructed; and
reconstruct an unobstructed first image by inpainting, into the at least one first segment of the first image, the at least one second portion of descriptive information from the at least one primary segment from the second image.

4. The electronic device of claim 3, wherein the processor is configured to cause the electronic device to:
determine, from the first image, one or more image characteristics from a group comprising: (i) coloration; (ii) orientation; (iii) size; (iv) skew; and (v) font of the section of the descriptive information; and
alter one or more corresponding image characteristics of the section of the unobstructed descriptive information received from the primary segment of the second image to match the one or more image characteristics of the first image.

5. The electronic device of claim 1, wherein the memory comprises at least one communication application, the one or more record comprises one or more communication record communicated via the at least one communication application, and the processor is further configured to cause the electronic device to:
associate the at least one first portion of the descriptive information with textual contents from the one or more communication record communicated via the at least one communication application; and
reconstruct the unobstructed first image by inpainting, into the at least one first segment of the first image, the at least one second portion of descriptive information comprising textual content from the one or more communication record combined with nontextual visual content that corresponds to adjacent portions of the first image.

6. The electronic device of claim 5, wherein the one or more communication record comprises at least one of a short message service (SMS) record and an email.

7. The electronic device of claim 1, wherein, in identifying the at least one second portion of the descriptive information contained in the one or more record and that is obscured from the first image, the processor is further configured to cause the electronic device to locate one or more of the descriptive information obfuscated in the first image by matching and extrapolating a location of the descriptive information in the other section of the first image.

8. The electronic device of claim 1, further comprising an image capturing device communicatively coupled to the processor, and wherein the processor is further configured to cause the electronic device to:
in response to an activation trigger prior to the trigger to reconstruct the first image, photographically capture the first image using the image capturing device.

9. A method comprising:
communicatively connecting, via a communications subsystem of an electronic device, to a communication network; and
in response to a trigger to reconstruct a first image that is partially obstructed:
identifying in the first image an obstruction obfuscating a section of the first image containing obstructed content;
identifying at least one first portion of descriptive information on another section of the first image that is unobstructed;
associating the at least one first portion of the descriptive information with contents of one or more record accessible in a memory of the electronic device or communicated via a communications subsystem of the electronic device;
identifying at least one second portion of the descriptive information contained in the one or more record and that is obscured from the first image;
delineating the first image into multiple segments comprising at least one first segment encompassing the section with the obstruction and which separates the obstruction from at least one second segment encompassing a visible portion of the other section of the first image that is unobstructed; and
reconstructing an unobstructed first image by inpainting, into the at least one first segment of the first image, the at least one second portion of descriptive information from the one or more record.

10. The method of claim 9, wherein the one or more record comprises a second image.

11. The method of claim 10, further comprising:
delineating the second image into multiple segments comprising at least one primary segment corresponding to the section with the obstruction in the first image and at least one secondary segment corresponding to the visible portion of the other section of the first image that is unobstructed; and
reconstructing an unobstructed first image by inpainting, into the at least one first segment of the first image, the at least one second portion of descriptive information from the at least one primary segment from the second image.

12. The method of claim 11, further comprising:
determining, from the first image, one or more image characteristics from a group comprising: (i) coloration; (ii) orientation; (iii) size; (iv) skew; and (v) font of the section of the descriptive information; and
altering one or more corresponding image characteristics of the section of the unobstructed descriptive information received from the at least one primary segment of the second image to match the one or more image characteristics of the first image.

13. The method of claim 9, further comprising:
associating the at least one first portion of the descriptive information with textual contents from the one or more record comprising one or more communication record communicated via at least one communication application executed by a processor of the electronic device; and
reconstructing the unobstructed first image by inpainting, into the at least one first segment of the first image, the at least one second portion of descriptive information comprising textual content from the one or more communication record combined with nontextual visual content that corresponds to adjacent portions of the first image.

14. The method of claim 13, wherein the one or more communication record comprises at least one of a short message service (SMS) record and an email.

15. The method of claim 9, wherein identifying the at least one second portion of the descriptive information contained in the one or more record and that is obscured from the first image further comprises locating one or more of the descriptive information obfuscated in the first image by matching and extrapolating a location of the descriptive information in the other section of the first image.

16. The method of claim 9, further comprising:
in response to an activation trigger prior to the trigger to reconstruct the first image, photographically capturing the first image using an image capturing device of the electronic device.

17. A computer program product comprising:
a computer readable storage device; and
program code on the computer readable storage device that when executed by a processor associated with an electronic device, the program code is configured to cause the electronic device to provide functionality of:
communicatively connecting, via a communications subsystem of an electronic device, to a communication network; and
in response to a trigger to reconstruct a first image that is partially obstructed:
identifying in the first image an obstruction obfuscating a section of the first image containing obstructed content;
identifying at least one first portion of descriptive information on another section of the first image that is unobstructed;
associating the at least one first portion of the descriptive information with contents of one or more record accessible in a memory of the electronic device or communicated via a communications subsystem of the electronic device;
identifying at least one second portion of the descriptive information contained in the one or more record and that is obscured from the first image;
delineating the first image into multiple segments comprising at least one first segment encompassing the section with the obstruction and which separates the obstruction from at least one second segment encompassing a visible portion of the other section of the first image that is unobstructed; and
reconstructing an unobstructed first image by inpainting, into the at least one first segment of the first image, the at least one second portion of descriptive information from the one or more record.

18. The computer program product of claim 17, wherein the program code is further configured to cause the electronic device to provide functionality of:
associating the at least one first portion of the descriptive information with textual contents from the one or more record comprising one or more communication record communicated via at least one communication application executed by a processor of the electronic device; and
reconstructing the unobstructed first image by inpainting, into the at least one first segment of the first image, the at least one second portion of descriptive information comprising textual content from the one or more communication record combined with nontextual visual content that corresponds to adjacent portions of the first image.

19. The computer program product of claim 17, wherein the one or more record comprises a second image, and the program code is further configured to cause the electronic device to provide functionality of:
delineating the second image into multiple segments comprising at least one primary segment corresponding to the section with the obstruction in the first image and at least one secondary segment corresponding to the visible portion of the other section of the first image that is unobstructed; and
reconstructing an unobstructed first image by inpainting, into the at least one first segment of the first image, the at least one second portion of descriptive information from the at least one primary segment from the second image.

20. The computer program product of claim 17, wherein the program code is further configured to cause the electronic device to provide functionality of:
associating the at least one first portion of the descriptive information with textual contents from the one or more record comprising one or more communication record communicated via at least one communication application executed by a processor of the electronic device; and
reconstructing the unobstructed first image by inpainting, into the at least one first segment of the first image, the at least one second portion of descriptive information comprising textual content from the one or more communication record combined with nontextual visual content that corresponds to adjacent portions of the first image.
